(19) United States
(12) Patent Application Publication
(10) Pub. No.: US 2017/0070804 A1
(43) Pub. Date: Mar. 9, 2017

(54) Multifunction Wireless Adapter

(71) Applicant: Monster, LLC, Las Vegas, NV (US)

(72) Inventors: Noel Lee, Las Vegas, NV (US); Anthony DiChiro, Chatsworth, CA (US); Demian Martin, San Leandro, CA (US)

(21) Appl. No.: 14/845,224

(22) Filed: Sep. 3, 2015

(51) Int. Cl. H04R 1/10; H04B 1/713

(52) U.S. Cl. CPC H04R 1/1041; H04R 1/1033; H04B 1/713; H04R 2201/107; H04R 2420/07; H04B 2201/71346

(57) ABSTRACT

The Invention is a Wireless Headphone System (WHS), comprising an adapter that is configured for use with headphones having dual connections for cables with one on each headphone. The invention uses that configuration to support a cable with connectors at both ends of the cable that is at least long enough to connect around the user's head between the ear cups of the headphone. Further it incorporates Bluetooth or other wireless electronics and may have a microphone for a full duplex conversation as well as controls. The preferred embodiment comprises a generally symmetrical cable that balances the mass of the device(s) along its length, which can also be used to share media with an additional headphone set that is also plugged into the device.

### FIELD OF THE INVENTION

This invention relates to a Bluetooth earphone, and more particularly to adding Bluetooth or other wireless capability to a passive earphone that is used with an active lifestyle

### DESCRIPTION OF THE RELATED ART

Bluetooth® is a recently developed but well known short range radio frequency communication standard, system and protocol. It is used in many different circumstances including, for example, communication between PCs, from PCs to hand held computers, from mobile telephones to PCs, and from mobile telephone handsets to ear pieces and headphones.

The Bluetooth system or standard as a whole allows a wide range of different communication regimes. It is therefore very flexible and is set up in a very generic way to allow use in all of these different ways. A Bluetooth earphone can cooperate with a mobile phone to avoid limitation of wires to a source device when being active while using an earphone to listen to media (music, movie/video sound, or other content or using for a phone call. Hence, Bluetooth earphones have been widely used.

Other wireless technologies are being developed as alternatives to Bluetooth, for example low power WiFi has been promoted for headphones and Microchip has a technology called Kleernet for supporting wireless headphones.

However, much of the current stock of headphones are not wireless enabled. As such, there is a need for devices that can adapt headphones for use with wireless technology. Currently, users with existing passive or active headphones without wireless capability, there are several options for adding wireless functionality. For purposes of illustration they are described as Medallion (Type 1), Plug in (Type 2) and “Mount” (type 3).

Medallion adapters (Type 1) refer to a Bluetooth electronic module with a short attached cable. These can be universal in application but the medallion is an object hanging from one side of the headphone that usually needs to be clipped to the user's clothing. These Medallion type devices are typically an unbalanced, non-symmetrical mass attached to the headphone on one side that impedes active use of the headphone.

The Plug in adapter (Type 2) module is similar to the medallion however it has no cable so it is rigidly attached to the headphone on one side. This type also creates significant imbalance and is typically designed for a particular headphone. Unfortunately, this type of adapter often comes loose (and unplugs) when used in an active lifestyle.

The Mount adapter (Type 3) typically uses adhesive to attach to the headphone creates an even less convenient and often unattractive attachment to a headphone and further imbalances the headphone.

Therefore there exists a need for a Bluetooth headphone adapter that overcomes the shortcomings of the prior art by providing a convenient, balanced and generally symmetrical adapter. The present invention provides that, as well as the additional functionality of simultaneous use by multiple users.

### SUMMARY OF THE INVENTION

In accordance with one aspect of the present invention, there is provided an adapter that is configured for use with headphones having dual connections for cables with one on each headphone. The invention uses that configuration to support a cable with connectors at both ends of the cable that is at least long enough to connect around the user's head between the ear cups of the headphone. Further it incorporates Bluetooth or other wireless electronics and may have a microphone for a full duplex conversation as well as controls. Further, to maintain balance along the length of the adapter cable, the battery is preferably mounted in or near the connector(s) at the end(s) of the cable. Further, the battery may be split between the two connectors to reduce the mass at each end of the cable, which further balances the mass.

In accordance with another aspect of the present invention, there is provided an additional benefit to this configuration in that the cable also enables sharing of audio between two sets of previously non-Bluetooth enabled headphones by connecting each end of the cable to a different headphone.

### BRIEF DESCRIPTION OF THE DRAWINGS

FIG. 1 illustrates a prior art Medallion (Type 1) Bluetooth adapter.

FIG. 2 illustrates a prior art Medallion (Type 1) Bluetooth adapter.

FIG. 3 illustrates a prior art Plug In (Type 2) Bluetooth adapter.

FIG. 4 illustrates a prior art Plug In (Type 2) Bluetooth adapter.

FIG. 5 illustrates a prior art Mounted (Type 3) Bluetooth adapter.

FIG. 6 illustrates a prior art Mounted (Type 3) Bluetooth adapter.

FIG. 7 illustrates a front view of an over the ear headphone configuration.

FIG. 8 illustrates a side view of an over the ear headphone configuration with an embodiment of the invention.

FIG. 9 illustrates an exterior view of an embodiment of the invention.

FIG. 10 illustrates a single headphone.

FIG. 11 illustrates a single headphone attached to a portable media device.

FIG. 12 illustrates a single headphone attached to a portable media device via a cable to the connection on the user's right side.

FIG. 13 illustrates an exterior view of an embodiment of the invention connected between the left and right ear cups of headphone.

FIG. 14 illustrates an embodiment of the invention connected between two headphones to share media between two users.

FIG. 15 illustrates an embodiment of the invention connected between two headphones to share media between three users.

FIG. 16 illustrates an embodiment of the invention connected between two headphones to share media between four users.

FIG. 17 illustrates the interior of a connector with a battery inside the connector housing.

FIG. 18 illustrates a front view of an embodiment of the invention with a controller device.

FIG. 19 illustrates a rear view of an embodiment of the invention with a controller device.

FIG. 20 illustrates a schematic/block diagram of an embodiment of the invention.

FIG. 21 illustrates a schematic/block diagram of an embodiment of the invention adding a second microphone to the assembly.

FIG. 22 illustrates a schematic/block diagram of an embodiment of the invention adding a third microphone to the assembly.

FIG. 23 illustrates the addition of microphones on the connectors

### DETAILED DESCRIPTION OF THE DRAWINGS

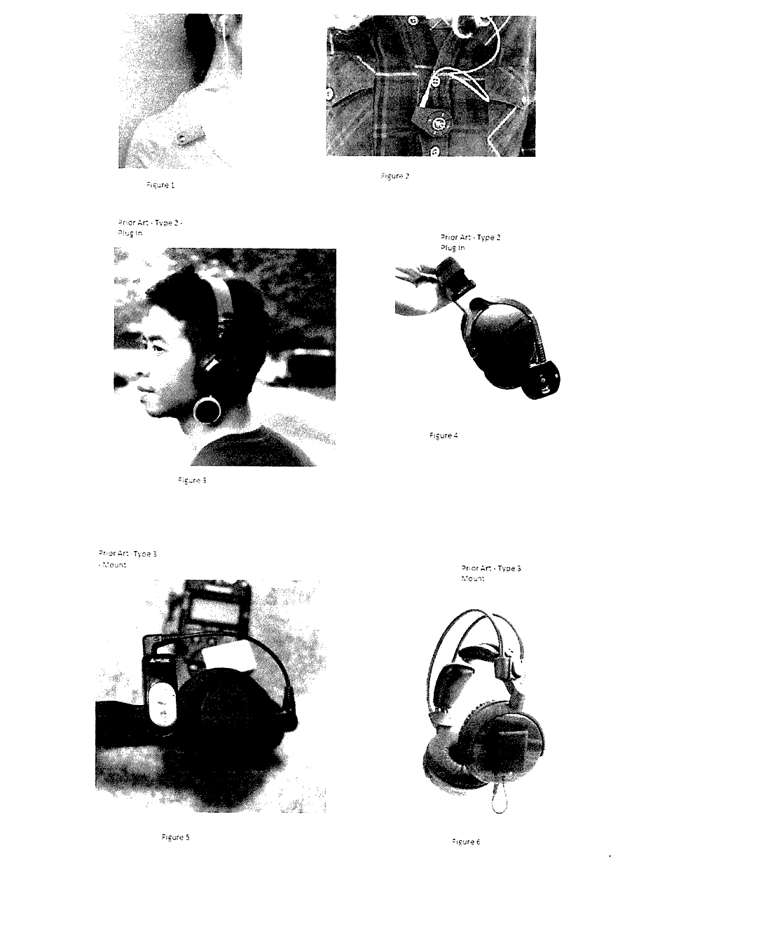

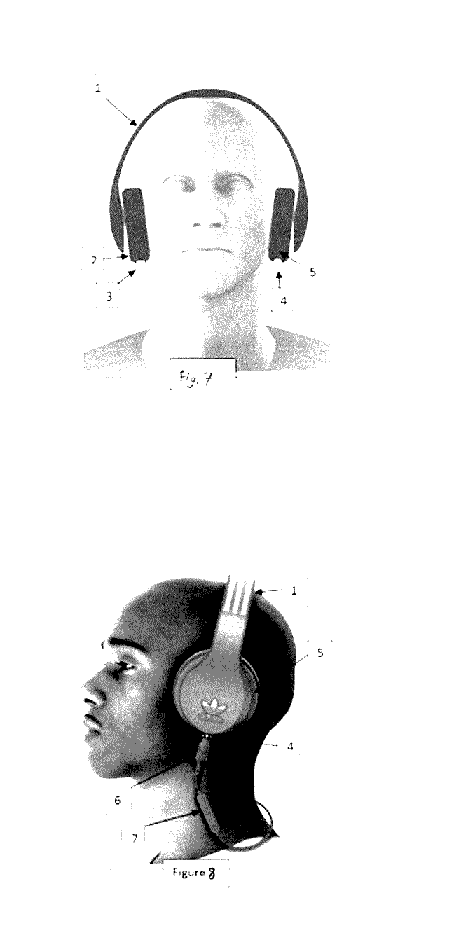

FIG. 1 and FIG. 2 illustrate prior art Medallions (Type 1) Bluetooth adapters. Medallion refers to a Bluetooth electronic module with a short attached cable. These can be universal in application but the medallion is an object hanging from one side of the headphone that usually needs to be clipped to the users clothing. In any case it is an unbalanced mass attached to the headphone impeding active use of the headphone.

FIG. 3 FIG. 4 illustrate prior art Plug In (Type 2) Bluetooth adapters. The Plug in module is similar to the medallion however it has no cable so it is rigidly attached to the headphone. It will be a more significant imbalance and needs to be designed specifically for a particular headphone or normal used will tend to knock it loose and prevent function. An example would be this The Plug In module is similar to the medallion however it has no cable so it is rigidly attached to the headphone. It will be a more significant imbalance and needs to be designed specifically for a particular headphone or normal used will tent to knock it loose and prevent function. An example would be the Adapt Bluetooth Headphone adapter from Outdoor Technologies.

FIG. 5 and FIG. 6 illustrate prior art Mounted (Type 3) Bluetooth adapters. The “Mount” version uses adhesive to attach to the headphone so it is more universal but creates an even less convenient and often unattractive attachment to a headphone and further imbalances the headphone.

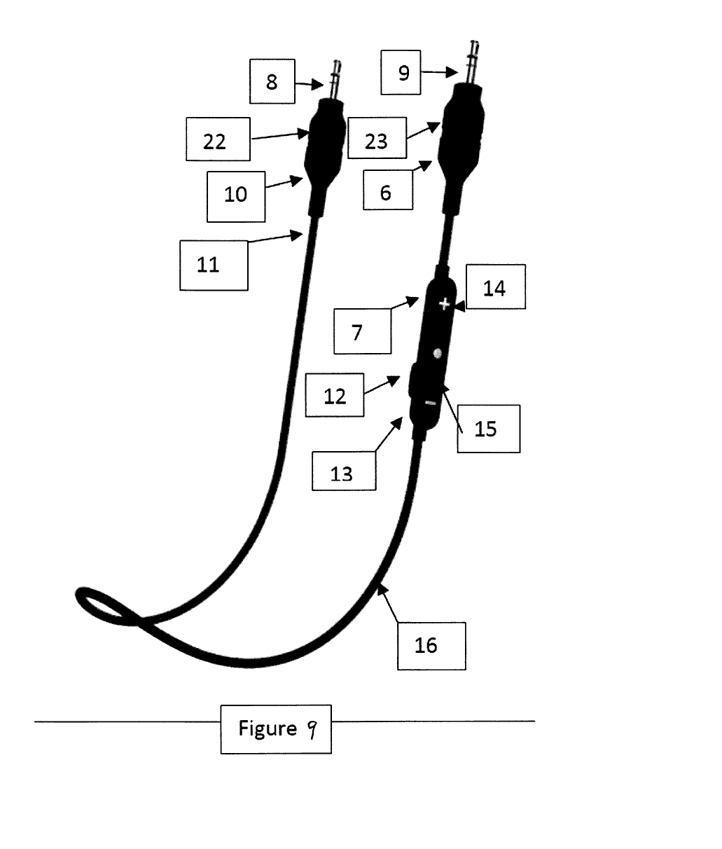

FIG. 7 illustrates a front view of an over the ear headphone configuration. Is current over the ear headphone practice. Headphone (1) comprises a right ear cup (2) with a connector (3) and a left ear cup (5) with a connector (4)

FIG. 8 illustrates a side view of an over the ear headphone configuration with an embodiment of the invention. Side view with “wireless cable” connected showing headband (1), left ear cup (5) with left connector (4) connected to one connector (6) on the wireless cable assembly (7).

FIG. 9 illustrates an exterior view of an embodiment of the invention. Wireless cable assembly with first connector (8), second connector (9) first connector body (10) second connector body (6), wireless module (7), controls (14), microphone (15), power/charging connector (13), cable (16).

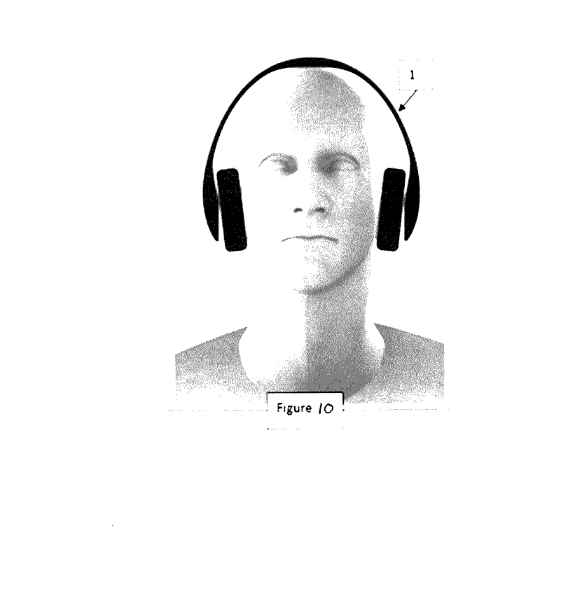

FIG. 10 illustrates a single headphone. Showing a single headphone (1)

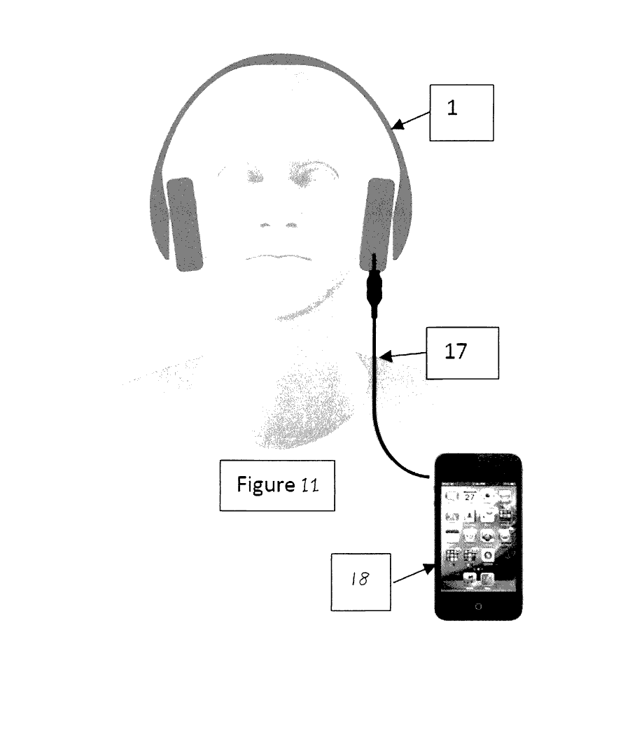

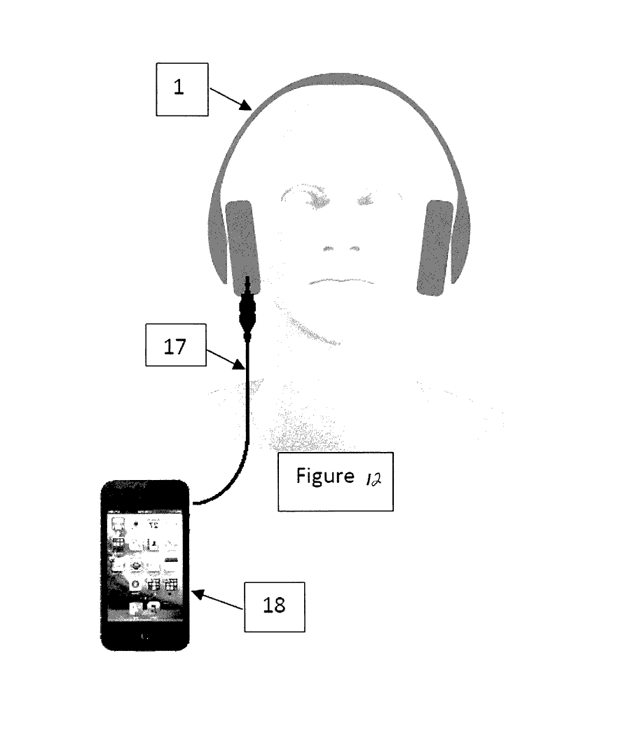

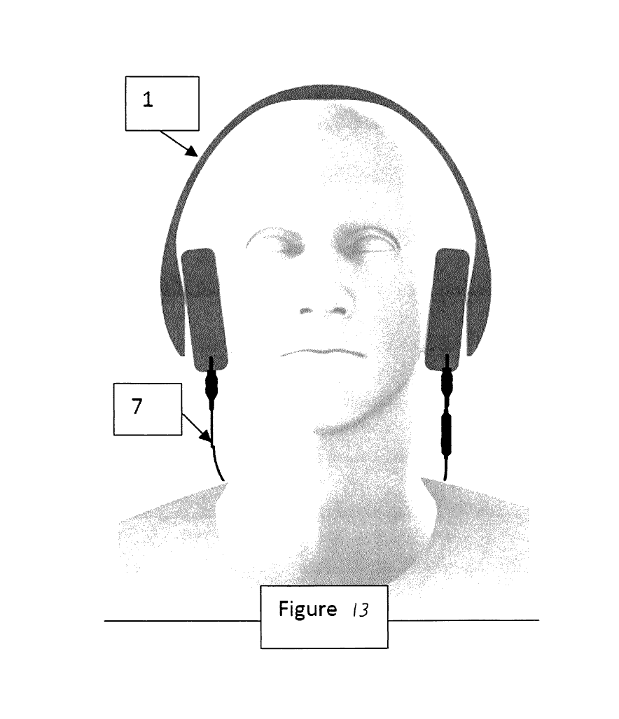

FIG. 11 illustrates a single headphone attached to a portable media device. Showing a single headphone (1) attached to a portable media device (18) via a cable (17) to the connection on the users left side.

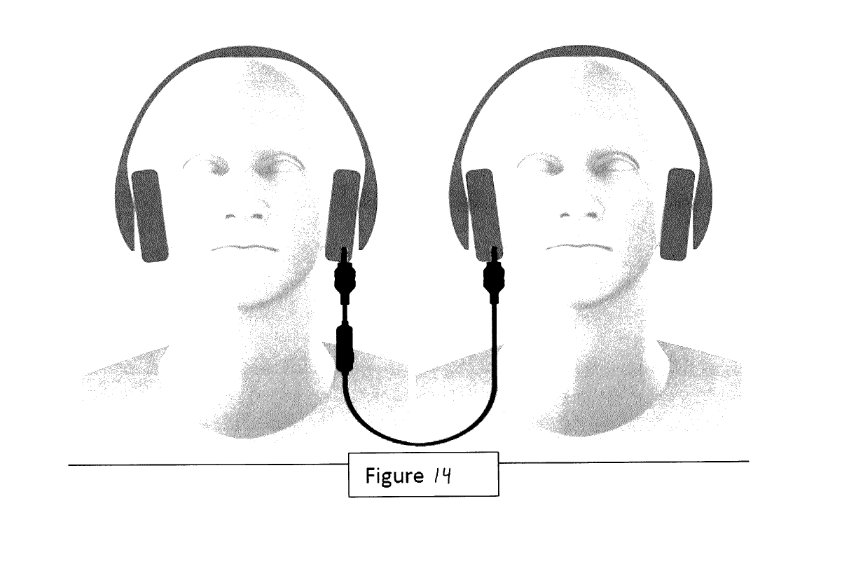

FIG. 12 illustrates a single headphone attached to a portable media device via a cable to the connection on the user's right side. Showing a single headphone (1) attached to a portable media device (18) via a cable (17) to the connection on the users right side.

FIG. 13 illustrates an exterior view of an embodiment of the invention connected between the left and right ear cups of headphone. Showing “wireless cable” (7) connected between the left and right ear cups of headphone (1).

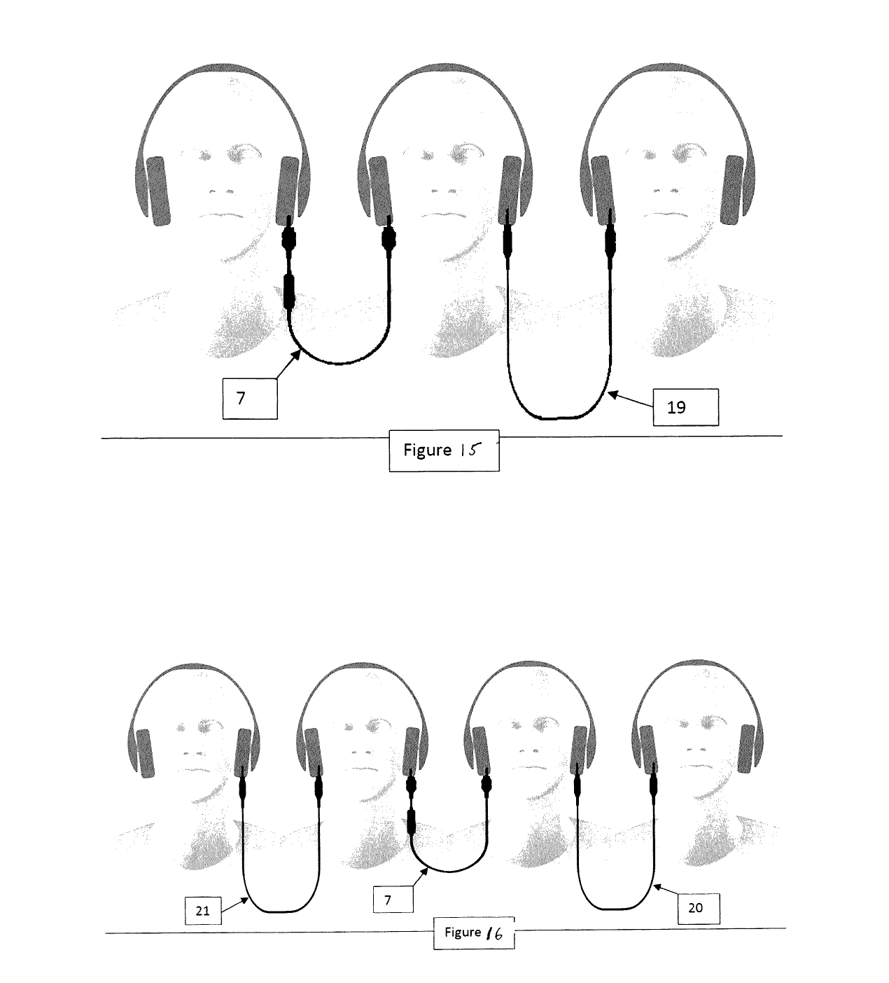

FIG. 14 illustrates an embodiment of the invention connected between two headphones to share media between two users. Showing “wireless cable” (7) connected between two headphones to share media between two users.

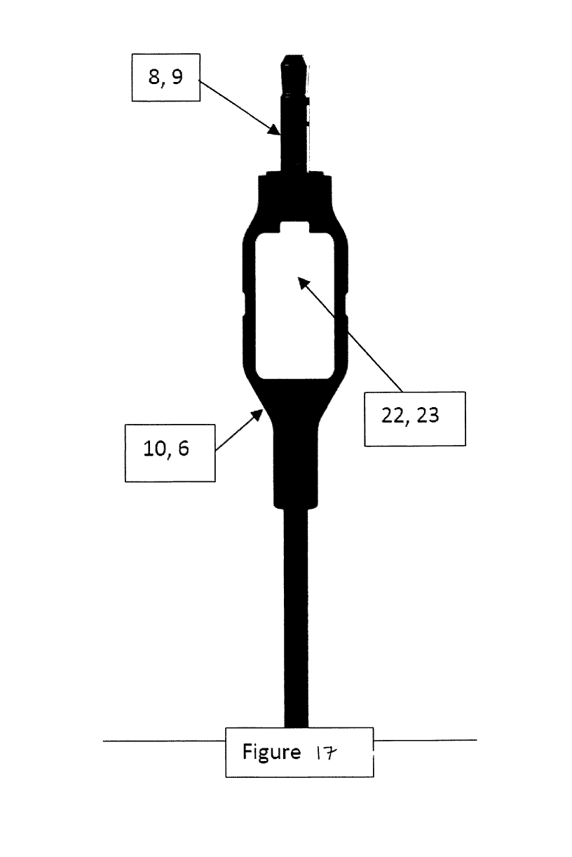

FIG. 15 illustrates an embodiment of the invention connected between two headphones to share media between three users. Showing the “wireless cable” (7) with the addition of a conventional cable (19) to share media between 3 people.

FIG. 16 illustrates an embodiment of the invention connected between two headphones to share media between four users. Showing the “wireless cable” (7) with the addition of conventional cables (19) & (20) to share media between 4 people.

FIG. 17 illustrates the interior of a connector with a battery inside the connector housing. Showing the interior of a connector (8, 9) with a battery (22, 23) inside the connector housing (10, 6).

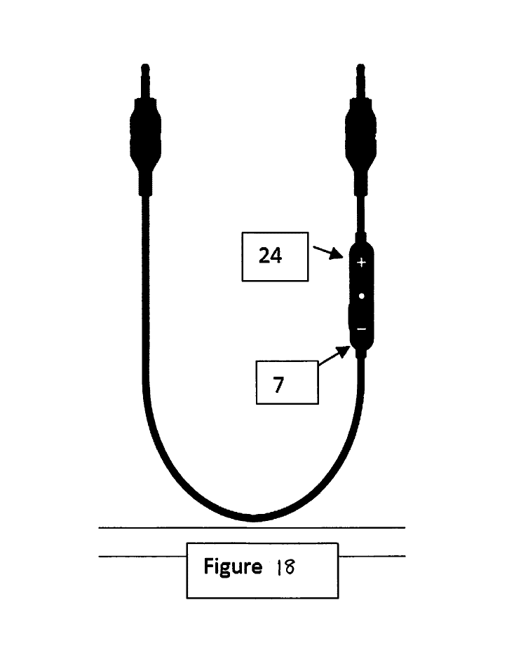

FIG. 18 illustrates a front view of an embodiment of the invention with a controller device. Showing a cable with a wireless module illustrating controls (7, 24).

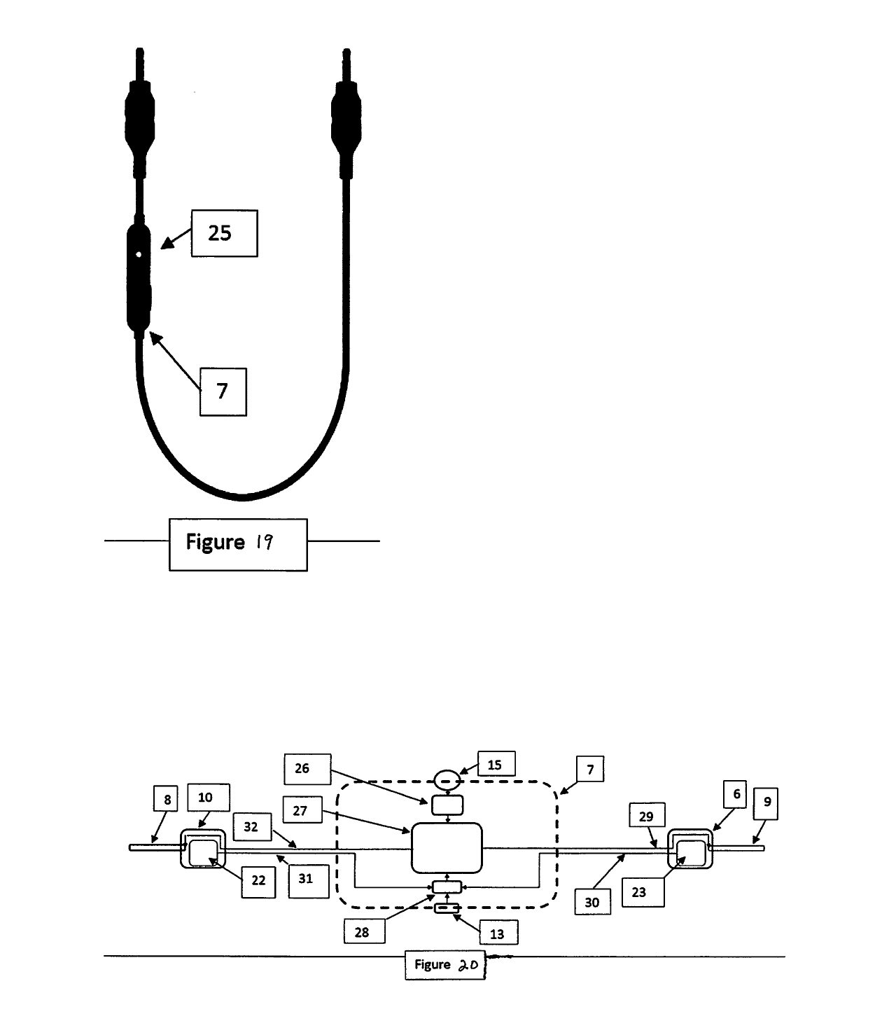

FIG. 19 illustrates a rear view of an embodiment of the invention with a controller device. Showing a cable with a wireless module illustrating control on obverse side (7, 25).

FIG. 20 illustrates a schematic/block diagram of an embodiment of the invention. These include connectors (8, 9) to transmit the stereo audio to the attached headphone, connector housings (6, 10) with batteries inside (22, 23) that provide a place to grip the connectors, strain relief for the cables and a place to house batteries, cabling with power conductors (30, 31) connecting the batteries to the wireless module (27) similar to one based on a CSR 8670 Bluetooth chip or a Gainspan low power wifi GS2011 which contains the radios used to connect to external audio sources, audio processing and amplification for the audio signals to drive the headphone, plus audio interfacing for the microphone if fitted. A microphone (15) for picking up voice communications on the wireless module housing (7) is connected to the wireless module via audio processing electronics (26). Power management electronics (28) controls the battery charge and power to the module. A power connection for charging (wired or wireless) (13) is also shown.

FIG. 21 illustrates a schematic/block diagram of an embodiment of the invention adding a second microphone to the assembly, which shows adding a second microphone (33) to the assembly to enable better noise reduction of ambient noise near the user. This would work in conjunction with a number of different noise reduction algorithms from vendors such as CSR's CVC noise reduction.

FIG. 22 illustrates a schematic/block diagram of an embodiment of the invention adding a third microphone to the assembly, showing a third microphone (33) added for additional directionality in the noise reduction for use with algorithms that support three microphones.

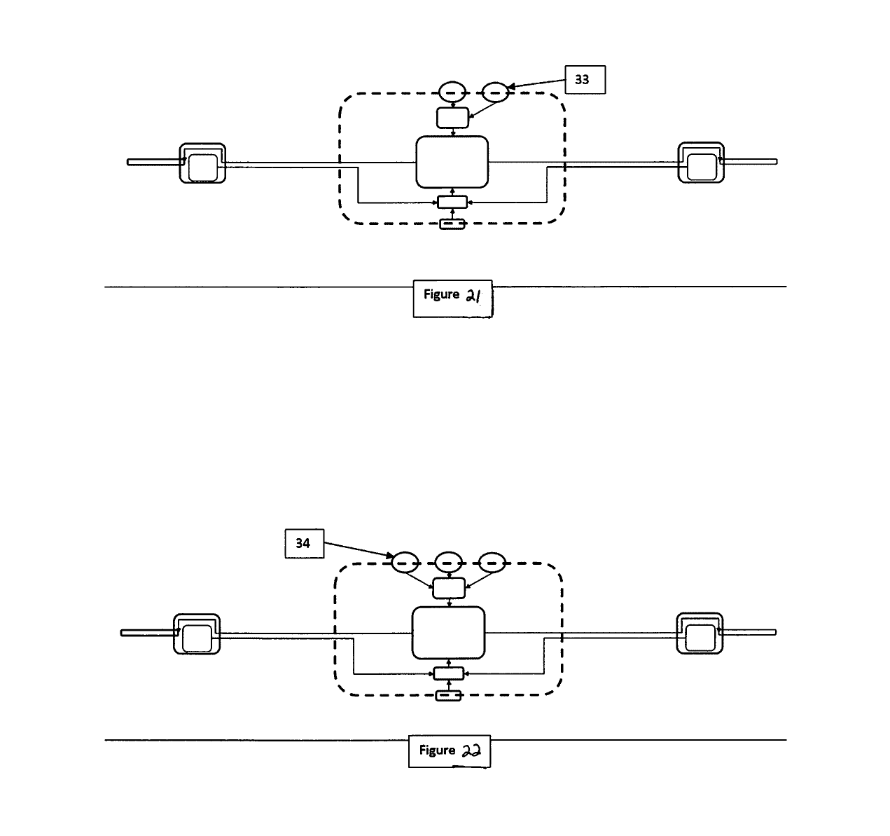

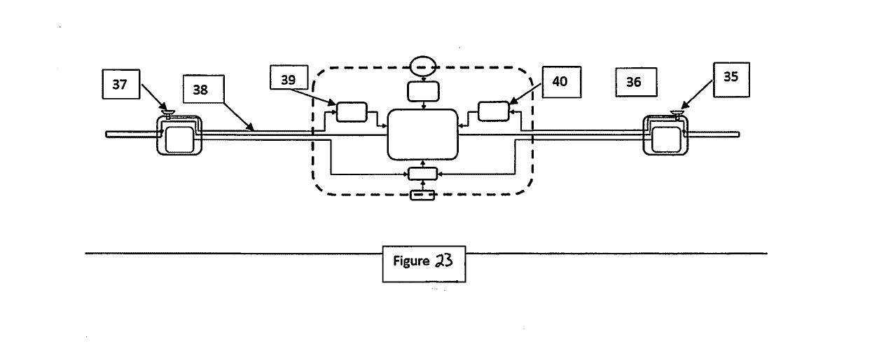

FIG. 23 illustrates the addition of microphones (35, 37) on the connectors, showing the addition of microphones (35, 37) on the connectors for use as a feedforward noise cancelling option connected via additional wires (38, 36) to the wireless module via noise cancelling conditioning electronics (39, 40) such as those provided by AMS 3415 or Wolfson Electronics WM2000. Putting the microphones on the connectors creates a consistent and predictable distance between the microphones and the audio drivers for the earphones. This is necessary for the feedforward noise cancelling algorithm to work properly since it needs to correct for time delay and signal loss between microphone and driver. In U. S. Pat. No. 8,682,250 B2 Anthony James Magrath and Clive Robert Graham show how to use more than one microphone per driver to improve noise cancellation, a technique which could be advantageously employed in this application to overcome possible alignment issues of the connector.

### DETAILED DESCRIPTION OF THE PREFERRED EMBODIMENT

Ref erring to FIGS. 9, 13, 17-23, the Multifunction Bluetooth or other wireless module Adapter comprises two connectors (8, 9) for connection to existing headphone or headphones. Attached to the connectors would be a connector body (10, 6) that could house the batteries necessary for the wireless electronics. Those would be attached to a cable (16) with internal wires that couple the signal connections from the wireless module (7) to the connectors (8, 9). The wireless module (7) would preferably contain the wireless electronics, a microphone (15), controls (14) and a charging connector (13). The battery could be located in the wireless module as an alternate option. The power connector could be replaced with internal wireless charging technology if so desired.

The advantages of this preferred embodiment include:
1) The cable is attached at both ends when in use so there is no free end or module (like the medallion) to drag against clothing or bounce or whip around during activity to disturb the wearer or those around the wearer.
2) If the batteries are in the connectors the mass is balanced to the ear cups and will have similar forces acting on the headphones when the user is moving quickly.
3) When sharing media with others there are two available connectors permitting connection to two headphones. Therefore a single adapter can be used by two users simultaneously.
4) Further sharing when used with headphones that have two connections becomes possible with additional conventional cables.

Other variations are possible, including where the battery is located in one connector and the wireless module is located in another connector, thus reducing the mass on the free portion (middle) of the cable.

Further enhancements can include the following:
1) Mounting the battery in one connector and the wireless module in another connector reduces the mass on the free part of the cable reducing the effects of motion on the combination.
2) Voice command controls can be incorporated with the wireless module giving an active user control even if the module is inconveniently located or the activity requires both hands.
3) Microphones with audio processing capabilities can be included either in the control/wireless module or in the connectors which can have any of the following enhancements: Enhanced audio processing to improve speech quality, local voice recognition capability that takes advantage of the close proximity of the microphones to improve speech recognition possibly incorporating audio processing as well as speech recognition technology.
4) Background noise canceling using microphones in the connector. Positioning the microphones on the connector near the headphone allows a noise cancelling technology to capture the noise source more accurately and can enable a reasonable form of feed forward noise cancelling
5) Special placement of buttons and controls can be incorporated for specific feature applications or to better support dexterity impaired individuals to use a headset's features. In particular a button on the back of the control module that can launch a specific application using either a wireless connection like Bluetooth or Bluetooth low energy or using various signaling techniques like ultrasonic tones on the microphone channel all of which are accepted practice.
6) While the description is for use with an over ear headphone it can be adapted to in ear headphones and on ear headphones.
7) Gesture controls, hand movement for control can be incorporated for controlling actions in either the wireless module or at a connected device using a protocol such as Bluetooth's AVRCP profile.
8) Exchangeable battery can be fitted to extend operating life without the down time for charging.

What is claimed is:

1) An adapter for providing a communication path between a wireless enabled portable electronic device and non-wireless enabled headphones, the adapter comprising:
a) a first connector, sized and configured to mate with a first plug receptacle on the headphone, configured to transmit stereo audio signals to the headphone;
b) a first connector housing;
c) a second connector, sized and configured to mate with a second plug receptacle on the headphone, configured to transmit stereo audio signals to the headphone;
d) a second connector housing;
e) a wireless module comprising signal connectors;
f) at least one battery configured to power the adapter; and
g) a cable portion located between the first and second connectors comprising internal wires that couple the signal connectors from the wireless module to the first and second connectors.

2) The adapter of claim 1, further comprising a microphone connected to the wireless module via audio processing electronics.

3) The adapter of claim 2, further comprising a wireless module housing.

4) The adapter of claim 3, wherein the microphone is connected to the wireless module on the wireless module housing.

5) The adapter of claim 1, further comprising a controller mechanism for controlling audio input and output.

6) The adapter of claim 1, wherein a first battery is located in the first connector housing.

7) The adapter of claim 6, wherein a second battery is located in the second connector housing.

8) The adapter of claim 6, wherein the wireless module is located in the second connector housing.

9) The adapter of claim 1, further comprising voice command controls incorporated into the wireless module.

10) The adapter of claim 1, wherein the wireless module is Bluetooth enabled.
